(19) United States
(12) Patent Application Publication
(10) Pub. No.: US 2002/0188779 A1
(43) Pub. Date: Dec. 12, 2002

(54) Apparatus for managing identification number, system for managing identification number and method for managing identification number

(76) Inventor: Akira Ochi, Ehime (JP)

Correspondence Address: Allen Ratner, Ratner & Prestia, One Westlakes Berwyn Suite 301, PO Box 980, Valley Forge, PA, 19482-0980, US

(21) Appl. No.: 10/049,977

(22) PCT Filed: Jun. 18, 2001
(86) PCT No.: PCT/JP01/05182

(30) Foreign Application Priority Data
Jun. 19, 2000 (JP) 2000-183611

(51) Int. Cl. G06F 13/00

(52) U.S. Cl. 710/104

(57) ABSTRACT

With conventional techniques, if a common identification number is set where there are two or more pieces of IEEE1394 equipment which can independently execute processing in one product, it is difficult to maintain the consistency of EUI-64 as product.

An identification number managing apparatus has

EUI-64 memory means 100 of saving an identification number which is processed as a common identifier in a plurality pieces of IEEE1394 equipment A101-C103 which can operate independently of each other; and

communications means 201-203 of forwarding the identification number to the plurality pieces of IEEE equipment,

characterized in that the IEEE1394 equipment A101-C103, upon acquisition of the identification number forwarded from the communications means, generates the identifier from the identification number and establishes a configuration ROM which contains the identifier.

### FIELD OF THE INVENTION

The present invention relates to digital audio/video equipment (AV equipment), and more particularly, to an identification number managing apparatus and an identification number managing method which are in compliance with IEEE1394 Standard and are for acquiring EUI-64 (Extended Unique Identifier-64Bit) in order to establish a configuration ROM which is the number unique to equipment.

### BACKGROUND ART

In recent AV systems and the like, many pieces of electronic equipment are connected with each other to build a system. For instance, in an AV system, a television set, a video tape recorder, a digital video camera and the like are connected via input/output terminals, whereby the AV system is built.

Standards which are appropriate to data communications in the age of multimedia have been proposed over the recent years, among which is “IEEE1394 High Performance Serial Bus Standard (hereinafter referred to as ‘IEEE1394 Standard’)” that realizes an environment for free large-capacity communications at a high speed.

By the way, a configuration ROM must be packaged in equipment supporting IEEE1394 Standard. A configuration ROM must hold information which is defined by IEEE1212 Standard, unique to an IEEE1394 machine, and necessary to establish communications for the IEEE1394 machine such as a capability as an IEEE1394 communications apparatus, an ID unique to the machine, etc.

FIG. 3 shows the format of a configuration ROM. In the configuration ROM, a bus information block (“bus_info_block” in FIG. 3) and additional information are described in a root directory (“rootdirectly” in FIG. 3) and below that. Not important in describing the present invention, the details of the structure of a configuration ROM will not be described here.

FIG. 4 is a view showing the format of the bus information block. The bus information block contains information which is indicative of an ID unique to equipment and other information. The other information herein referred to, not being important in describing the present invention, will not be described here.

IDs unique to IEEE1394 equipment are called “EUI-64 (Extended Unique Identifier-64Bit) and respectively have independent numbers which include numbers unique to a company manufacturing the equipment, numbers unique to the equipment, etc. FIG. 5 shows the format of EUI-64. As shown in FIG. 5, node_vender ID is an ID number set in advance and unique to a manufacturer of IEEE1394 equipment, while chip_id_hi and chip_id_lo are areas in which any desired data can be stored.

Next, FIG. 6 is a view schematically showing the structure of IEEE1394 equipment. In FIG. 6, denoted at 601 is an EUI-64 memory apparatus and denoted at 602 is a configuration ROM (Conf.ROM).

The IEEE1394 equipment reads EUI-64 written in the EUI-64 memory apparatus 601, copies EUI-64 to a register which is within the configuration ROM 602 and establishes the configuration ROM based on these unique information, whereby the IEEE1394 equipment becomes operable on a network to which the IEEE1394 equipment is connected via an IEEE1394 bus.

By the way, when there are two or more pieces of equipment complying with IEEE1394 which can independently execute processing in one product or when a plurality pieces of IEEE1394 equipment are to be handled as the same product through an IEEE1394 network, as a common identification number is set to each piece of the IEEE1394 equipment which exists as a part of one product, it is possible to set EUI-64 for the product as a whole using the common identification number. With respect to operations of the equipment on the IEEE1394 network, when there are a plurality pieces of the same second equipment, for instance, which can communicate with predetermined first equipment on the network, this identification number can be used to select and use some specific pieces of the second equipment which work well with the predetermined first equipment (for example, products manufactured by the same manufacturer and existing in the same housing, or products which operate while working together for the same purpose). At this stage, the identification numbers stored in EUI-64s of the respective pieces of equipment are referred to by third equipment which serves as a third party and accordingly become recognizable.

In an effort to realize such a structure, to store identification numbers in the respective pieces of IEEE1394 equipment, it is necessary during manufacturing steps to ensure the consistency of the identification numbers among the respective pieces of IEEE1394 equipment, e.g., by setting the same identification number to be stored in the EUI-64 memory apparatuses.

However, with implementation of the structure above, upon a failure or fault of a certain piece of IEEE1394 equipment in the same product for example, as this piece of equipment is replaced with a new piece of IEEE1394 equipment, if the new piece of IEEE1394 equipment has a different identification number, the product may cause inconsistency of EUI-64.

### SUMMARY OF THE INVENTION

The present invention has been made in view of the circumstances described above. Accordingly, an object of the present invention is to provide an identification number managing apparatus, an identification number managing method, an identification number managing system, etc., which can maintain consistency of EUI-64 as one product even when there are two or more pieces of equipment complying with IEEE1394 which can independently execute processing in one product.

To achieve the above object, the 1st invention of the present invention (corresponding to claim 1) is an identification number managing apparatus, comprising:

memory means of saving an identification number which is processed as a common identifier in a plurality pieces of IEEE1394 equipment which can operate independently of each other; and

communications means of forwarding said identification number to said plurality pieces of IEEE equipment,

characterized in that said IEEE1394 equipment, upon acquisition of said identification number forwarded from said communications means, generates said identifier from said identification number and establishes a configuration ROM which contains said identifier.

Further, the 2nd invention of the present invention (corresponding to claim 2) is the invention mentioned above, characterized in that said plurality pieces of IEEE1394 equipment are configured as one product,

and that said identifier indicates that said plurality pieces of IEEE1394 equipment are said one product.

Further, the 3rd invention of the present invention (corresponding to claim 3) is the identification number managing apparatus in accordance with claim 1 or 2, characterized in that said identification number is in compliance with IEEE1212 Standard.

Further, the 4th invention of the present invention (corresponding to claim 4) is the IEEE1394 equipment which works together with an identification number managing apparatus in accordance with any one of 1st through 3rd inventions, characterized in comprising means of processing said identification number as said identifier which can be included in said configuration ROM.

The 5th invention of the present invention (corresponding to claim 5) is an identification number managing system, characterized in comprising:

the identification number managing apparatus in accordance with any one of the 1st through 3rd inventions; and

IEEE1394 equipment in accordance with the 4th invention.

The 6th invention of the present invention (corresponding to claim 6) is an identification number managing method, comprising:

a memory step of saving an identification number which is processed as a common identifier in a plurality pieces of IEEE1394 equipment which can operate independently of each other;

a communications step of forwarding said identification number to said plurality pieces of IEEE1394 equipment;

a generation step at which said plurality pieces of IEEE1394 equipment, upon acquisition of said identification number forwarded from said communications means, generate said identifier from said identification number; and

an establishment step at which said plurality pieces of IEEE1394 equipment establish a configuration ROM which contains said identifier.

The 7th invention of the present invention (corresponding to claim 7) is the invention mentioned above, characterized in that said plurality pieces of IEEE1394 equipment are configured as one product,

and that said identifier indicates that said plurality pieces of IEEE1394 equipment are said one product.

The 8th invention of the present invention (corresponding to claim 8) is the invention mentioned above, characterized in that said identification number is in compliance with IEEE1212 Standard.

The 9th invention of the present invention (corresponding to claim 9) is a program which makes a computer function as all or a part of memory means of saving an identification number which is processed as a common identifier in a plurality pieces of IEEE1394 equipment which can operate independently of each other of an identification number managing apparatus and all or a part of communications means of forwarding said identification number to said plurality pieces of IEEE equipment in accordance with the 1st invention.

The 10th invention of the present invention (corresponding to claim 10) is a program which makes a computer function as all or a part of means of processing said identification number as said identifier which can be included in said configuration ROM in IEEE1394 equipment in accordance with the 4th invention.

The 11th invention of the present invention (corresponding to claim 11) is a program which makes a computer function as all or a part of memory means of saving an identification number which is processed as a common identifier in a plurality pieces of IEEE1394 equipment which can operate independently of each other in an identification number managing apparatus in accordance with any one of the 1st through 3rd inventions, all or a part of communications means of forwarding said identification number to said plurality pieces of IEEE equipment, and all or a part of means of processing said identification number as said identifier which can be included in said configuration ROM in IEEE1394 equipment in accordance with the 4th invention in an identification number managing system in accordance with the 5th invention.

The 12th invention of the present invention (corresponding to claim 12) is a program which makes a computer execute all or some of:

a memory step of saving an identification number which is processed as a common identifier in a plurality pieces of IEEE1394 equipment which can operate independently of each other;

a communications step of forwarding said identification number to said plurality pieces of IEEE1394 equipment;

a generation step at which said plurality pieces of IEEE1394 equipment, upon acquisition of said identification number forwarded from said communications means, generate said identifier from said identification number; and

an establishment step at which said plurality pieces of IEEE1394 equipment establish a configuration ROM which contains said identifier or an identification number managing method in accordance with the 6th invention.

The 13th invention of the present invention (corresponding to claim 13) is a medium which can be processed by a computer and holds a program which makes a computer function as all or a part of memory means of saving an identification number which is processed as a common identifier in a plurality pieces of IEEE1394 equipment which can operate independently of each other of an identification number managing apparatus and all or a part of communications means which forwards said identification number to said plurality pieces of IEEE equipment in accordance with the 1st invention.

The 14th invention of the present invention (corresponding to claim 14) is a medium which can be processed by a computer and holds a program which makes a computer function as all or a part of means of processing said identification number as said identifier which can be included in said configuration ROM in IEEE1394 equipment in accordance with the 4th invention.

The 15th invention of the present invention (corresponding to claim 15) is a medium which can be processed by a computer and holds a program which makes a computer function as all or a part of memory means, which saves an identification number which is processed as a common identifier in a plurality pieces of IEEE1394 equipment which can operate independently of each other in an identification number managing apparatus in accordance with any one of the 1st through 3rd inventions in an identification number managing system all or a part of communications means which forwards said identification number to said plurality pieces of IEEE equipment, and all or a part of means of processing said identification number as said identifier which can be included in said configuration ROM in IEEE1394 equipment in accordance with the 4th invention, in accordance with the 5th invention.

The 16th invention of the present invention (corresponding to claim 16) is a medium which can be processed by a computer and holds a program which makes a computer execute all or some of:

a memory step of saving an identification number which is processed as a common identifier in a plurality pieces of IEEE1394 equipment which can operate independently of each other;

a communications step of forwarding said identification number to said plurality pieces of IEEE1394 equipment;

a generation step at which said plurality pieces of IEEE1394 equipment, upon acquisition of said identification number forwarded from said communications means, generate said identifier from said identification number; and

an establishment step at which said plurality pieces of IEEE1394 equipment establish a configuration ROM which contains said identifier or an identification number managing method in accordance with the 6th invention.

According to the present invention, where there are two or more pieces of equipment complying with IEEE1394 which can independently execute processing in one product, upon a failure or fault of a certain piece of IEEE1394 equipment in the product, even when this piece of equipment is replaced with a new piece of IEEE1394 equipment, it is possible to maintain consistency of EUI-64 as one product.

Further, where there are two or more pieces of equipment complying with IEEE1394 which can independently execute processing in one product, upon a failure or fault of a certain piece of IEEE1394 equipment in the product, even when this piece of equipment is replaced with a new piece of IEEE1394 equipment, since EUI-64s are generated from an identification number which serves as a base, the inconsistency as one product will not arise.

### BRIEF DESCRIPTION OF THE DRAWINGS

FIG. 1 is a structure diagram of an identification number managing system according to a preferred embodiment of the present invention;

FIG. 2 is a drawing showing an example of EUI-64 of a product according to a first preferred embodiment of the present invention;

FIG. 3 is a schematic diagram of the format of a configuration ROM;

FIG. 4 is a schematic diagram of the format of a bus information block;

FIG. 5 is a schematic diagram of the format of EUI-64; and

FIG. 6 is a drawing modeling a flow of EUI-64 according to a conventional technique.

### DESCRIPTION OF THE REFERENCE SYMBOLS

| | |
|---|---|
| 100 | EUI-64 memory apparatus |
| 101, 102, 103 | IEEE1394 equipment |
| 201, 202, 203 | communications means |
| 301, 302, 303 | bit processing means |

### MOST PREFERRED EMBODIMENT FOR IMPLEMENTING THE INVENTION

In the following, a preferred embodiment of the present invention will be described with reference to the drawings.

<Preferred Embodiment>

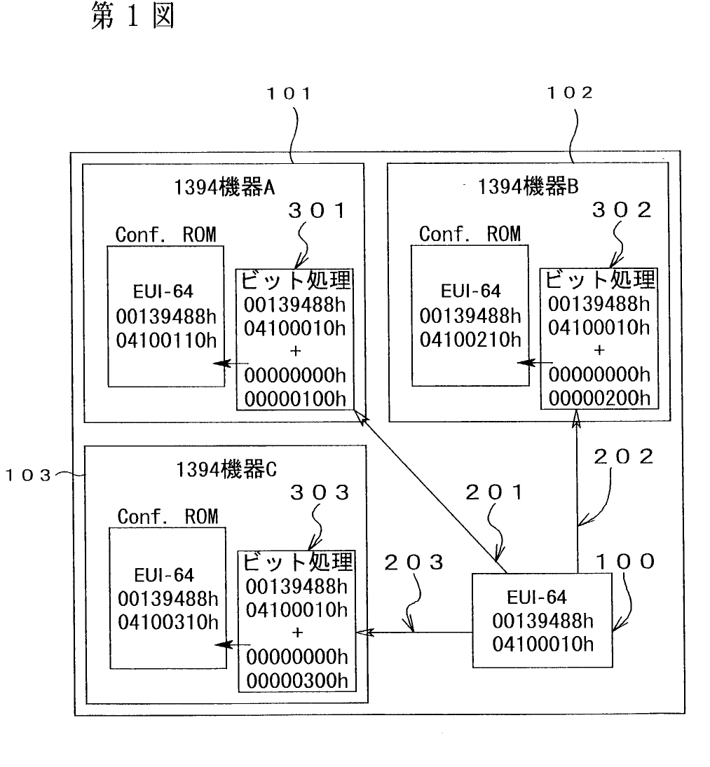

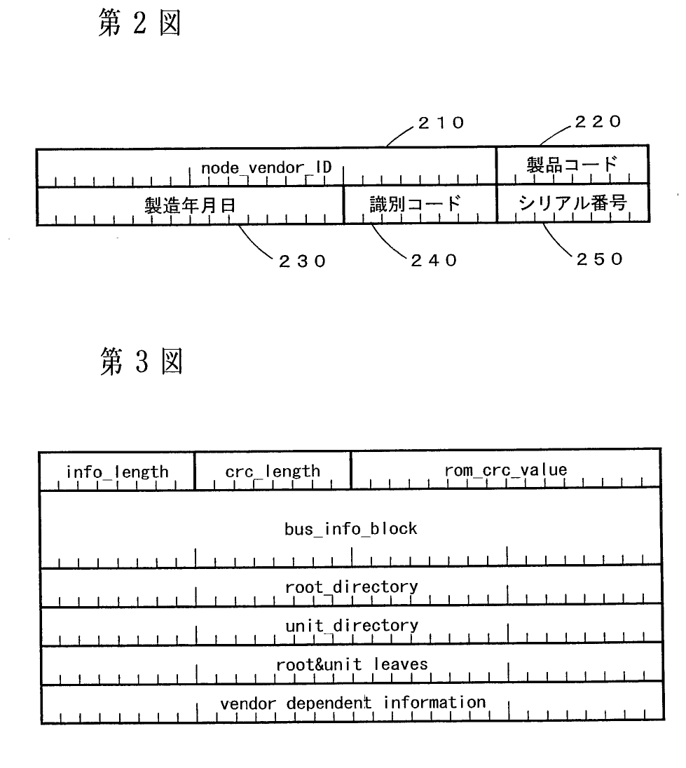

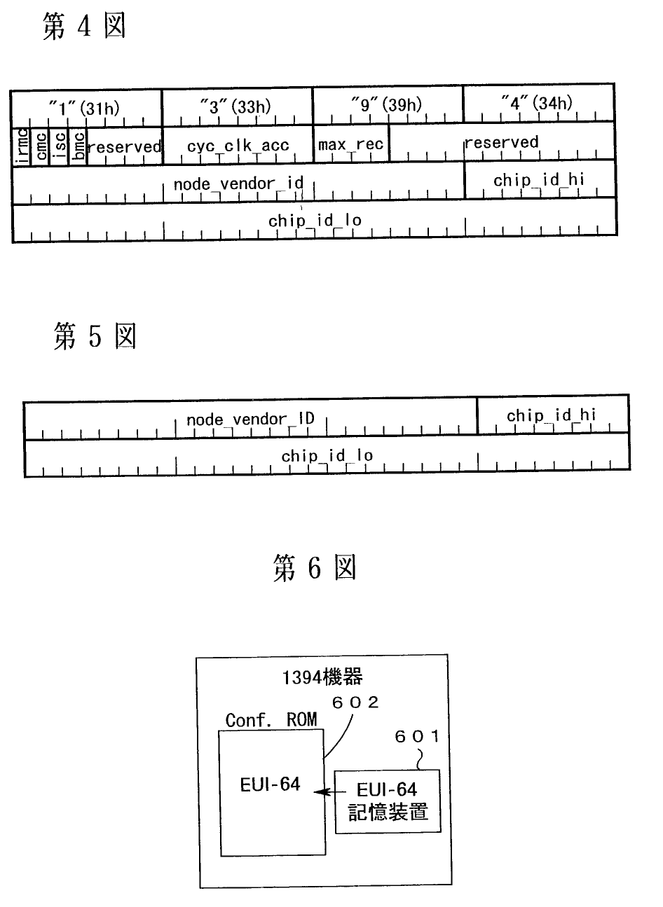

FIG. 1 is a structure diagram showing an arrangement that a plurality pieces of IEEE1394 equipment are disposed in the housing of one product, as an example of an identification number managing system which is formed by an identification number managing apparatus according to a preferred embodiment of the present invention and IEEE1394 equipment which operates together with the identification number managing apparatus. In FIG. 1, denoted at 100 is an EUI-64 memory apparatus which corresponds to memory means of the present invention, denoted at 101 is an IEEE1394 instrument A, denoted at 102 is an IEEE1394 instrument B, denoted at 103 is an IEEE1394 instrument C, denoted at 201 is communications means for communications between the EUI-64 memory apparatus 100 and the IEEE1394 instrument A101, denoted at 202 is communications means for communications between the EUI-64 memory apparatus 100 and the IEEE1394 instrument B102, and denoted at 203 is communications means for communications between the EUI-64 memory apparatus 100 and the IEEE1394 instrument C103, of which all elements are realized to include cables and interfaces which do not comply with IEEE1394 Standard. In the IEEE1394 instruments A101, B102 and C103, denoted at 301, 302 and 303 are bit processing means which correspond to processing means of the present invention. Further, although not shown in the drawings, the EUI-64 memory apparatus 100 and the IEEE1394 instruments A101 through C103 share the same power source and accordingly turn on and off at once.

Next, FIG. 2 is a drawing showing an example of the format of EUI-64 within the IEEE1394 instruments according to this preferred embodiment. In FIG. 2, node_vendor_ID 210 in the upper row is a number which is unique to a manufacturer of the IEEE1394 equipment, the product code 220 is a number which is common to the respective 1394 instruments and corresponds to an identification number or identifier of the present invention. Of these, the product code 220 is an example of data held in chip_id_hi. Meanwhile, the date of manufacture 230, an identification code 240 and a serial number 250 are an example of data held in chip_id_lo. The identification code 240, in particular, is a code for identifying each one of the IEEE1394 instruments A101 through B103 which are in the product.

Further, in FIG. 1, the figures in two rows one on the top and the other on the bottom are hexadecimal representation of the EUI-64 format each in the top row and the bottom row. For instance, in the EUI-64 memory apparatus 100, the figures in the top row “00139488h” express data strings in the node_vendor_ID 210 and the product code 220 which the EUI-64 memory apparatus 100 holds, while the figures in the bottom row “04100010h” express data strings in the date of manufacture 230, the identification code 240 and the serial number 250.

Now, a description will be given on operations in an identification number managing system which is formed by the identification number managing apparatus according to the preferred embodiment of the present invention and IEEE1394 equipment which operates together with the identification number managing apparatus. An identification number managing method according to the present invention will be described along with this.

First, it is assumed that the identification code of the IEEE1394 instrument A101 is 01h, the identification code 240 of the IEEE1394 instrument B102 is 02h, the identification code 240 of the IEEE1394 instrument C103 is 03h and the respective identification codes are stored in the bit processing means 301, 302 and 303, respectively. It is also assumed that the bit processing means 301, 302 and 303 do not hold any data other than the identification code 240 in relation to EUI-64s.

The product code 220, which ensures the consistency as a product common to the respective IEEE1394 instruments A101 through C103, is held in the EUI-64 memory apparatus 100 but not set in the bit processing means 301 through 303 of the IEEE1394 instruments A101 through C103. In addition, it is assumed that the EUI-64 memory apparatus 100 holds all data except for the identification code 240 in relation to EUI-64s.

As the entire system is turned on in such a condition, the EUI-64 memory apparatus 100 starts up first, which is followed by activation of the respective IEEE1394 instruments A101 through C103.

As the IEEE1394 instruments A101 through C103 start up, the EUI-64 memory apparatus 100 transmits its own EUI-64 to these instruments through the communications means 201, 202 and 203 before executing an operation of setting a configuration ROM.

Upon receipt of the EUI-64 transmitted from the EUI-64 memory apparatus 100, the respective 1394 instruments, using the bit processing means 301, 302 and 303, generate EUI-64s which correspond to the respective instruments. For instance, in the IEEE1394 instrument A101, upon receipt of the EUI-64 transmitted from the EUI-64 memory apparatus 100, the bit processing means 301 adds the received EUI-64 to its own EUI-64. Since the top row reads “00139488h” and the bottom row reads “04100010h” in the EUI-64 transmitted from the EUI-64 memory apparatus 100 while the top row reads “0000000h” and the bottom row reads “0000100h” in the EUI-64 which is held in the bit processing means 301, the resultant top row is “00139488h” and the resultant bottom row is “04100110h” after the addition and these figures become new EUI-64 which is to be set in a configuration ROM of the IEEE1394 instrument A101. A similar operation to that in the IEEE1394 instrument A101 is executed in the IEEE1394 instruments B102 and C103, thereby obtaining new EUI-64s. At this stage, the new EUI-64s contain the product code 220, which is set by the EUI-64 memory apparatus 100 and common to the respective IEEE1394 instruments, in data strings in the top rows and the identification code 240 unique to the respective IEEE1394 instruments in data strings in the bottom rows.

At last, using the newly acquired EUI-64s, each one of the IEEE1394 instruments A101 through C103 establishes a configuration ROM and accordingly becomes operable on an IEEE1394 network.

Next, when the IEEE1394 instrument C103 for instance is removed from the system and replaced with other IEEE1394 instrument, the EUI-64 memory apparatus 100 transmits EUI-64 again to the replacing IEEE1394 instrument, and this IEEE1394 instrument adds the EUI-64 received from the EUI-64 memory apparatus 100 to its own EUI-64, acquires EUI-64 which contains the product code 220 which is common to the IEEE1394 instruments A101 and B102 and establishes a configuration ROM. At this stage, “00139488h” is a data string in the top row of the EUI-64 which is set in the configuration ROM of this IEEE1394 instrument, and this data string is the same as those in the other IEEE1394 instruments and the EUI-64 memory apparatus 100 in the system.

Thus, according to the preferred embodiment, the product code is set which serves as identification numbers which are unique information used for identifying the respective IEEE1394 instruments as a product, and the product code is shared by the respective IEEE1394 instruments. Hence, the respective IEEE1394 instruments can establish configuration ROMs using the product code such that the consistency as one product is always maintained.

Further, since IEEE1394 equipment does not need to hold an identification code upon manufacturing or hold an EUI-64 memory apparatus itself, it is possible to decrease the number of components in a memory apparatus which saves EUI-64s and reduce manufacturing steps for writing EUI-64s.

Although the foregoing has described the preferred embodiment on an assumption that all data except for the identification code 240 are stored in EUI-64s of the EUI-64 memory apparatus 100 and the identification code 240 alone is stored in EUI-64s of the bit processing means 301 through 303 of the IEEE1394 instruments A101 through C103, the EUI-64 memory apparatus 100 only needs to hold at least the identification code 240 which serves as identification numbers in the present invention, and therefore, the other data may be stored in the IEEE1394 instruments in advance. In addition, although the foregoing has described that calculation for setting EUI-64s in the bit processing means 301 through 303 is addition in the preferred embodiment above, this merely is one example. The calculation may be other arithmetic style such as multiplication and division.

Further, the EUI-64 memory apparatus and the IEEE1394 instruments may be integrated with each other. The preferred embodiment above may be modified such that the EUI-64 memory apparatus 100 is incorporated within the IEEE1394 instrument A101 and the EUI-64 memory apparatus 100 as such transmits EUI-64 to the other IEEE1394 instruments B102 and C103.

Further, although the foregoing has described the preferred embodiment in relation to a configuration that the IEEE1394 instruments and the EUI-64 memory apparatus are housed in the integrated housing and accordingly operate using the common power source, the present invention is not limited to this. Instead, as long as the IEEE1394 instruments and the EUI-64 memory apparatus can communicate with each other via the communications means, these apparatuses may not be disposed in an integrated arrangement. Moreover, to the extent that the order in which the EUI-64 memory apparatus sets up EUI-64s to the IEEE1394 instruments is maintained, the power source as well may be independent to each instrument.

Furthermore, although the foregoing has described that the EUI-64 memory apparatus holds EUI-64s which are adapted to configuration ROMs complying with IEEE1212 of the respective IEEE1394 instruments according to the preferred embodiment above, the present invention is not limited to this. Instead, the format of data processed between the EUI-64 memory apparatus 100 and the bit processing means 301 through 302 before included in configuration ROMs may be modified in accordance with a revision made to the standard, such as IEEE1212r, or other format.

Further, although the foregoing has described the preferred embodiment in relation to an identification number managing system which is formed by the identification number managing apparatus according to the preferred embodiment of the present invention and IEEE1394 equipment which operates together with the identification number managing apparatus, the present invention may be a program which works together with a computer and makes the computer execute the functions of all or some means (or apparatuses, elements, circuits, units, etc.) of the identification number managing apparatus, the IEEE1394 equipment and the identification number managing system.

Further, the present invention may be a program which works together with a computer and makes the computer carry out the operations at all or some steps (or processes, operations, effects, etc.) of the identification number managing method described above according to the present invention.

Further, the present invention may be a medium which can be read on a computer and holds a program which is for making a computer execute all or some functions of all or some means of the identification number managing apparatus according to the present invention, so that the program as being read and working together with the computer execute the functions.

Further, the present invention may be a medium which can be read on a computer and holds a program which is for making a computer execute all or some operations at all or some steps of the identification number managing method according to the present invention, so that the program as being read and working together with the computer performs the operations.

Some means (or apparatuses, elements, circuits, units, etc.) of the present invention and some steps (or processes, operations, effects, etc.) of the present invention means a few or several means and steps among the plurality of means and steps or a part of the function or operation of one means or at one step.

In addition, some apparatuses (or elements, circuits, units, etc.) of the present invention means a few or several apparatuses among the plurality of apparatuses (or elements, circuits, units, etc.) or a part of the function within one of the means.

The present invention also covers a recording medium which can be read on a computer and holds the program according to the present invention.

An embodiment regarding use of the program according to the present invention may be a use wherein the program is recorded on a recording medium which can be read on a computer and works together with a computer.

Alternatively, an embodiment regarding use of the program according to the present invention may be a use wherein the program is transmitted in a transmission medium, read on a computer and works together with the computer.

Data structures according to the present invention include a database, a data format, a data table, a data list, a data type, etc.

Recording mediums include ROMs and the like, while transmission mediums include the Internet, a transmission mechanism such as optical fibers, light, electric waves, acoustic waves, etc.

The computers mentioned above according to the present invention are not limited to pure hardware such as a CPU but may include firmware, OS, and further, peripheral equipment.

As described above, the configuration according to the present invention may be realized by software, or alternatively, hardware.

### INDUSTRIAL USE OF THE INVENTION

As described above, even when one piece of IEEE1394 equipment malfunctions or fails in one product which contains a plurality pieces of equipment which are in compliance with IEEE1394, the present invention makes it possible to replace the malfunctioning or failing piece of IEEE1394 equipment as a component, and therefore, maintain the consistency as one product.

In addition, it is possible to decrease the number of components in a memory apparatus which saves EUI-64 directed to each IEEE1394 instrument and reduce manufacturing steps for writing EUI-64s.

1. An identification number managing apparatus, comprising:
memory means of saving an identification number which is processed as a common identifier in a plurality pieces of IEEE1394 equipment which can operate independently of each other; and
communications means of forwarding said identification number to said plurality pieces of IEEE equipment,
characterized in that said IEEE1394 equipment, upon acquisition of said identification number forwarded from said communications means, generates said identifier from said identification number and establishes a configuration ROM which contains said identifier.

2. The identification number managing apparatus in accordance with claim 1, characterized in that said plurality pieces of IEEE1394 equipment are configured as one product, and that said identifier indicates that said plurality pieces of IEEE1394 equipment are said one product.

3. The identification number managing apparatus in accordance with claim 1 or 2, characterized in that said identification number is in compliance with IEEE1212 Standard.

4. IEEE1394 equipment which works together with an identification number managing apparatus in accordance with any one of claims 1 through 3, characterized in comprising means of processing said identification number as said identifier which can be included in said configuration ROM.

5. An identification number managing system, characterized in comprising:
the identification number managing apparatus in accordance with any one of claims 1 through 3; and
IEEE1394 equipment in accordance with claim 4.

6. An identification number managing method, comprising:
a memory step of saving an identification number which is processed as a common identifier in a plurality pieces of IEEE1394 equipment which can operate independently of each other;
a communications step of forwarding said identification number to said plurality pieces of IEEE1394 equipment;
a generation step at which said plurality pieces of IEEE1394 equipment, upon acquisition of said identification number forwarded from said communications means, generate said identifier from said identification number; and
an establishment step at which said plurality pieces of IEEE1394 equipment establish a configuration ROM which contains said identifier.

7. The identification number managing method in accordance with claim 6, characterized in that said plurality pieces of IEEE1394 equipment are configured as one product,
and that said identifier indicates that said plurality pieces of IEEE1394 equipment are said one product.

8. The identification number managing method in accordance with claim 6 or 7, characterized in that said identification number is in compliance with IEEE1212 Standard.

9. A program which makes a computer function as all or a part of memory means of saving an identification number which is processed as a common identifier in a plurality pieces of IEEE1394 equipment which can operate independently of each other of an identification number managing apparatus and all or a part of communications means of forwarding said identification number to said plurality pieces of IEEE equipment in accordance with claim 1.

10. A program which makes a computer function as all or a part of means of processing said identification number as said identifier which can be included in said configuration ROM in IEEE1394 equipment in accordance with claim 4.

11. A program which makes a computer function as all or a part of memory means of saving an identification number which is processed as a common identifier in a plurality pieces of IEEE1394 equipment which can operate independently of each other in an identification number managing apparatus in accordance with any one of claims 1 through 3 all or a part of communications means of forwarding said identification number to said plurality pieces of IEEE equipment, and all or a part of means of processing said identification number as said identifier which can be included in said configuration ROM in IEEE1394 equipment in accordance with claim 4 in an identification number managing system in accordance with claim 5.

12. A program which makes a computer execute all or some of:
a memory step of saving an identification number which is processed as a common identifier in a plurality pieces of IEEE1394 equipment which can operate independently of each other;
a communications step of forwarding said identification number to said plurality pieces of IEEE1394 equipment;
a generation step at which said plurality pieces of IEEE1394 equipment, upon acquisition of said identification number forwarded from said communications means, generate said identifier from said identification number; and
an establishment step at which said plurality pieces of IEEE1394 equipment establish a configuration ROM which contains said identifier or an identification number managing method in accordance with claim 6.

13. A medium which can be processed by a computer and holds a program which makes a computer function as all or a part of memory means of saving an identification number which is processed as a common identifier in a plurality pieces of IEEE1394 equipment which can operate independently of each other of an identification number managing apparatus and all or a part of communications means which forwards said identification number to said plurality pieces of IEEE equipment in accordance with claim 1.

14. A medium which can be processed by a computer and holds a program which makes a computer function as all or a part of means of processing said identification number as said identifier which can be included in said configuration ROM in IEEE1394 equipment in accordance with claim 4.

15. A medium which can be processed by a computer and holds a program which makes a computer function as all or a part of memory means, which saves an identification number which is processed as a common identifier in a plurality pieces of IEEE1394 equipment which can operate independently of each other in an identification number managing apparatus in accordance with any one of claims 1 through 3 in an identification number managing system all or a part of communications means which forwards said identification number to said plurality pieces of IEEE equipment, and all or a part of means of processing said identification number as said identifier which can be included in said configuration ROM in IEEE1394 equipment in accordance with claim 4, in accordance with claim 5.

16. A medium which can be processed by a computer and holds a program which makes a computer execute all or some of:
a memory step of saving an identification number which is processed as a common identifier in a plurality pieces of IEEE1394 equipment which can operate independently of each other;
a communications step of forwarding said identification number to said plurality pieces of IEEE1394 equipment;
a generation step at which said plurality pieces of IEEE1394 equipment, upon acquisition of said identification number forwarded from said communications means, generate said identifier from said identification number; and
an establishment step at which said plurality pieces of IEEE1394 equipment establish a configuration ROM which contains said identifier or an identification number managing method in accordance with claim 6.
